(19) United States
(12) Patent Application Publication
(10) Pub. No.: US 2016/0191774 A1
(43) Pub. Date: Jun. 30, 2016

(54) Multi-Aperture Imaging Systems

(71) Applicant: Google Inc., Mountain View, CA (US)

(72) Inventors: Changyin Zhou, San Jose, CA (US); Roman Lewkow, San Jose, CA (US)

(73) Assignee: Google Inc., Mountain View, CA (US)

(21) Appl. No.: 14/259,919

(22) Filed: Apr. 23, 2014

(51) Int. Cl. H04N 5/225

(52) U.S. Cl. CPC H04N 5/2258

(57) ABSTRACT

An example dual imaging system includes a first imaging system that further includes a first image sensor; a first aperture that defines, at least in part, a field of view of the first imaging system; and a first reflector comprising an opening. The first reflector faces the first aperture. The first imaging system further includes a second reflector that faces the first reflector. The second reflector is located between the first aperture and the first reflector. The first image sensor, the first aperture, the first reflector, and the second reflector are all arranged around a common optical axis. The system further includes a second imaging system arranged substantially within the first imaging system. The second imaging system includes a second image sensor, and a second aperture that defines, at least in part, a field of view of the second imaging system.

### BACKGROUND

Unless otherwise indicated herein, the materials described in this section are not prior art to the claims in this application and are not admitted to be prior art by inclusion in this section.

Advances in computational imaging have led to interesting applications of multi-camera imaging systems. Two or more cameras may capture images of the same scene from different viewpoints and/or under different capture conditions, and computational imaging techniques may be used to form a composite image based on the two or more captured images. Such techniques include dynamic range enhancement and multi-spectrum imaging, among others. Image processing techniques may be used to overcome or alleviate parallax effects caused by the different viewpoints of the two or more cameras.

### SUMMARY

Multi-camera systems are useful for simultaneously capturing images of the same object from different viewpoints and/or different capture conditions. But, the differing viewpoints of the cameras cause a parallax effect where the same object appears to be at different respective positions within the fields of view of the cameras. That is, along two different lines of sight, the same object may have two different apparent positions within captured images. In addition, the object may appear to be in front of (or behind) different surroundings from each viewpoint. While a parallax effect may be advantageous in certain applications such as stereoscopic imaging and depth extraction, it may complicate computational imaging techniques such as dynamic range enhancement, multi-spectrum imaging, and virtual frame rate enhancement. Because cameras of traditional multi-camera systems are not aligned on the same optical axis, they do not capture images from the same viewpoint and the parallax effect is unavoidable.

Disclosed herein is a multi-camera system configured to reduce (and hopefully eliminate) parallax disparity by capturing images of an object with cameras having a common viewpoint. Such cameras can have different optical characteristics (e.g. field of view, light sensitivity, spectral response) while still sharing the same viewpoint, which can be advantageous for the applications such as those listed above. In some embodiments, a first camera and a second camera are aligned along an optical axis with the second camera positioned within the first camera. An aperture of the second camera may be positioned behind (or in front of) an aperture of the first camera. Similarly, an image sensor of the first camera may be located behind an image sensor of the second camera. Light that is captured by the first camera may travel past the second camera. Although the second camera blocks a direct line of sight between the optical axis and the first camera's image sensor, the first camera is configured to redirect light to the image sensor of the first camera after the light has passed the second camera.

In one example, a system is provided that includes a first imaging system that further includes a first image sensor; a first aperture that defines, at least in part, a field of view of the first imaging system; and a first reflector comprising an opening. The first reflector faces the first aperture. The first imaging system further includes a second reflector that faces the first reflector and is located between the first aperture and the first reflector. The first image sensor, the first aperture, the first reflector, and the second reflector are all arranged around a common optical axis. The system further includes a second imaging system arranged substantially within the first imaging system. The second imaging system includes a second image sensor and a second aperture that defines, at least in part, a field of view of the second imaging system. The second aperture and the second image sensor are arranged around the common optical axis. The second reflector is located between the first reflector and the second image sensor and between the first reflector and the second aperture, such that the field of view of the first imaging system and the field of view of the second imaging system are both substantially centered on the common optical axis.

In another example, a system is provided that includes a first imaging system that includes a first image sensor; a first aperture that defines, at least in part, a field of view of the first imaging system; and a first reflector that faces the first aperture. The first image sensor, the first aperture, and the first reflector are all arranged around a common optical axis. The system further includes a second imaging system arranged substantially within the first imaging system. The second imaging system includes a second image sensor and a second aperture that defines, at least in part, a field of view of the second imaging system. The second aperture and the second image sensor are arranged around the common optical axis. The first image sensor is located between the first reflector and the second image sensor and between the first reflector and the second aperture, such that the field of view of the first imaging system and the field of view of the second imaging system are both substantially centered on the common optical axis.

In yet another example, a system is provided that includes a first imaging system that includes a first image sensor; a first aperture that defines, at least in part, a field of view of the first imaging system; and a first reflector comprising an opening. The first reflector faces the first aperture. The first imaging system further includes a second reflector that faces the first reflector and is located between the first aperture and the first reflector. The first imaging system further includes at least one lens. The first image sensor, the first aperture, the first reflector, the second reflector, and the at least one lens are all arranged around a common optical axis. The system further includes a second imaging system arranged substantially within the first imaging system. The second imaging system includes a second image sensor; and a second aperture that defines, at least in part, a field of view of the second imaging system. The second aperture and the second image sensor are arranged around the common optical axis. The second reflector is located between the second image sensor and the first reflector and between the second aperture and the first reflector, such that the field of view of the first imaging system and the field of view of the second imaging system are both substantially centered on the common optical axis.

These as well as other aspects, advantages, and alternatives, will become apparent to those of ordinary skill in the art by reading the following detailed description, with reference where appropriate to the accompanying figures.

### BRIEF DESCRIPTION OF THE FIGURES

FIG. 1 illustrates an example computing device by which an example method may be implemented.

FIG. 2A illustrates a side view cross section of an example dual imaging system.

FIG. 2B is a downward view of portions of the example dual imaging system of FIG. 2A.

FIG. 2C is a downward view of portions of the example dual imaging system of FIG. 2A.

FIG. 3A illustrates a side view cross section of an example dual imaging system.

FIG. 3B is a downward view of portions of the example dual imaging system of FIG. 3A.

FIG. 3C illustrates an example image sensor of the system of FIG. 3A.

FIG. 3D illustrates a side view cross section of an example dual imaging system.

FIG. 4A illustrates a side view cross section of an example dual imaging system.

FIG. 4B illustrates a downward looking view of the example dual imaging system of FIG. 4A.

FIG. 5A illustrates an image captured by an image sensor.

FIG. 5B illustrates an image captured by an image sensor.

### DETAILED DESCRIPTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems and methods can be arranged and combined in a wide variety of different configurations, all of which are contemplated herein.

In a first embodiment, a dual imaging system may include a first imaging system comprising a first reflector and a second reflector that collectively redirect light to a first image sensor. In some cases, a second imaging system may be mounted (directly or indirectly) to a non-reflective surface of the second reflector. The first imaging system may have a field of view at least partially defined by a first aperture and the second imaging system may have a field of view at least partially defined by a second aperture located behind (or in front of) the first aperture.

In a second embodiment, a dual imaging system may include a first imaging system comprising a first reflector that redirects light to a first image sensor. In some cases, a second imaging system may be mounted (perhaps indirectly) to an inactive surface of the first image sensor. The first imaging system may have a field of view at least partially defined by a first aperture and the second imaging system may have a field of view at least partially defined by a second aperture located behind (or in front of) the first aperture.

In a third embodiment, a dual imaging system may include a first imaging system comprising a first reflector and a second reflector that collectively redirect light to a first image sensor. In some cases, a second imaging system may be mounted (perhaps indirectly) to a non-reflective surface of the second reflector. The first imaging system may have a field of view at least partially defined by a first aperture and the second imaging system may have a field of view at least partially defined by a second aperture located behind (or in front of) the first aperture. The first imaging system may include at least one lens also configured to redirect light to the first image sensor.

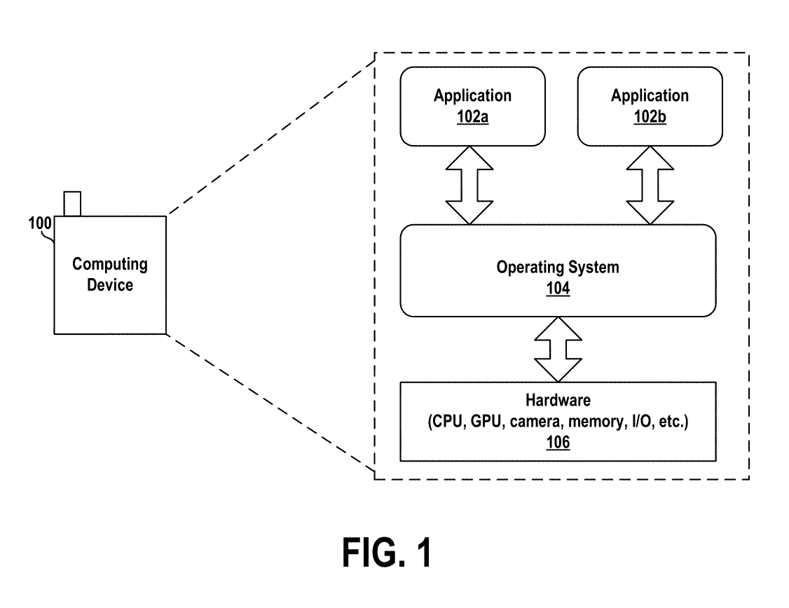

FIG. 1 illustrates an example computing device 100 by which an example method may be implemented. Computing device 100 may include applications 102a and 102b and an operating system 104 being executed by hardware 106. Aspects of this disclosure are applicable to computing devices such as PCs, laptops, tablet computers, smartphones, still-frame cameras, video cameras, real-time image viewers etc.

Each of the applications 102a and 102b may include instructions that, when executed, cause the computing device 100 to perform specific tasks or functions. Applications 102a and 102b may be native applications (i.e., installed by a manufacturer of the computing device 100 and/or a manufacturer of the operating system 104) or may be a third-party applications installed by a user of the computing device 100 after purchasing the computing device. A non-exhaustive list of example applications includes: a media player application that accepts media files as inputs and generates corresponding video and/or audio to the output device(s); an e-reader application which accepts electronic documents (books, magazines, etc.) as input and presents the content of the document via the output device(s); a feed reader that accepts feeds delivered over the Internet (e.g., RSS feeds and/or feeds from social network sites) as input and presents the feeds via the output device(s); a map application that displays a map via the output device(s); a note-taking application, a bookmarking application, and a word processing, spreadsheet, and/or presentation application that accepts specifically formatted files as inputs and presents them via the output devices for viewing and/or editing. The applications may also include a still-frame image capture application or a video camera application.

The operating system 104 may interact with and manage hardware 106 to provide services for the applications 102a and 102b. For example, an application 102a may request that the operating system 104 direct an integrated camera(s) of hardware 106 to capture a visual image and that the hardware 106 store the image to memory or display a modified image on a user display. Or, an application 102a may request that the operating system 104 direct a GPS receiver of hardware 106 to detect the geolocation of the computing device 100. In some embodiments, the computing device may include firmware instead of, or in addition to, an operating system 104. Other examples are possible.

The hardware 106 may include, for example, a central processing unit (CPU), a graphics processor (GPU), memory, an input/output (I/O) interface, a GPS receiver, image capture devices (cameras), inertial sensors, microphones, user input device(s), and output device(s). Components of hardware 106 may be controlled by instructions contained in applications 102a and 102b and operating system 104. Other examples are possible.

The central processing unit (CPU) may be operable to effectuate the operation of the computing device 100 by executing instructions stored in memory or disk storage. Such instructions may include the operating system 104 and the applications 102a and 102b. The CPU may, for example, comprise a single or multi-core processor, an application specific integrated circuit (ASIC), field programmable gate array (FPGA), and/or any other suitable circuitry.

The graphics processor may be operable to generate a video stream for output to the screen based on instructions and/or data received from the CPU. That is, data structures corresponding to images to be displayed on the screen may be stored to and read from the memory or disk storage by the CPU. The data may also be transferred directly from the integrated camera. The CPU may convey such data structures to the graphics processor via a standardized application programming interface (API) such as, for example, Standard Widget Toolkit (SWT), the DirectX Video Acceleration API, the Video Decode Acceleration Framework API, or other suitable API.

The memory may include program memory and run-time memory. The memory may, for example, comprise non-volatile memory, volatile memory, read only memory (ROM), random access memory (RAM), flash memory, magnetic storage, and/or any other suitable memory. Program memory may store instructions executable by the CPU to effectuate operation of the operating system 104 and the applications 102a and 102b. Runtime memory may store data generated or used during execution of the operating system 104 or applications 102a and 102b.

The input/output (I/O) interface may be operable to receive signals from the input device(s), and provide corresponding signals to the CPU and/or the graphics processor.

The input device(s) may include, for example, a mouse, a touchpad, a motion sensor, a trackball, a voice recognition device, a keyboard, or any other suitable input device which enables a user to interact with the computing device 100.

The output devices may include, for example, a screen and speakers. The screen may be, for example, a liquid crystal display (LCD) screen, an OLED screen, an e-ink screen, and/or any other suitable device for presenting a graphical user interface.

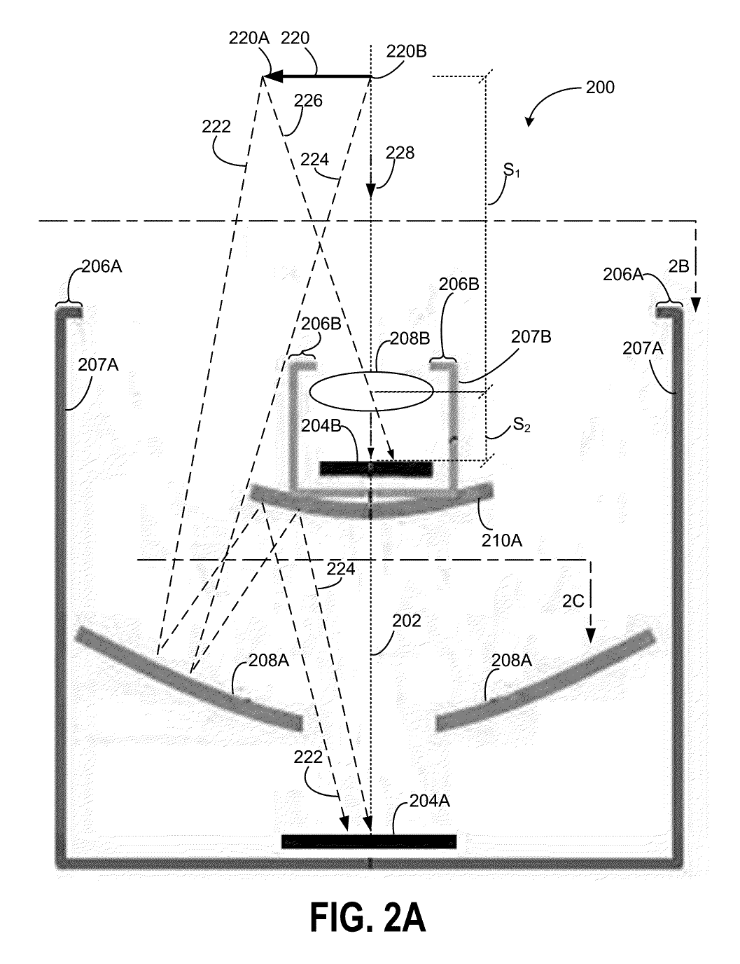

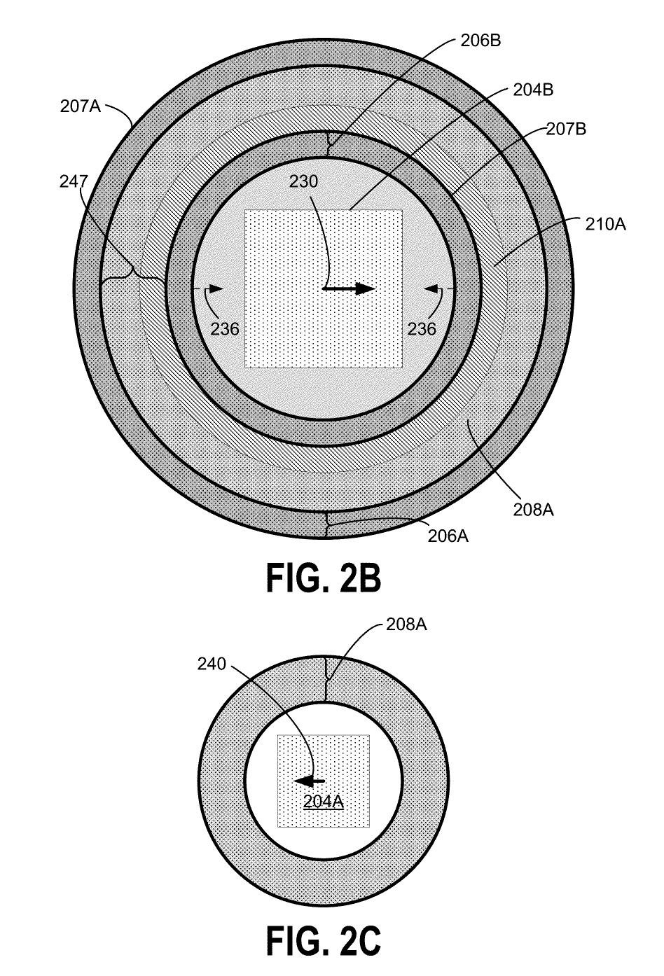

FIG. 2A illustrates a side view cross section of an example dual imaging system 200. A first imaging system of the dual imaging system 200 further includes a first image sensor 204A, a first aperture stop 206A, a first wall 207A, a first reflector 208A, and a second reflector 210A. The dual imaging system 200 also includes a second imaging system comprising a second image sensor 204B, a second aperture stop 206B, a second wall 207B, and a lens 208B. FIG. 2A further includes an object 220 with a first end 220A and a second end 220B, and light rays 222, 224, 226, and 228. Both the first and second image sensors 204A and 204B may be configured to capture light travelling downward relative to the optical axis 202. Any portions or components of the dual imaging system may be arranged along, or around, a common optical axis 202.

It should be noted that dimensions of the dual imaging system 200 or the object 220 represented in FIG. 2 may not be to scale, and are for illustrative purposes only. It should also be noted that any depicted angles and/or directions of refraction or reflection depicted in FIG. 2A are purely for illustrative purposes and are not necessarily to scale.

The optical axis 202 may define an axis of rotational symmetry (or other axis of symmetry) for image sensors 204A and 204B, the aperture stops 206A and 206B, the first reflector 208A, the lens 208B, the second reflector 210A, and the dual imaging system 200 as a whole. For example, a light ray such as the light ray 228 that travels along the optical axis 202 may pass through a second aperture defined by the aperture stop 206B, pass through the lens 208B, and reach the second image sensor 204B without being refracted (i.e. having its direction of travel changed). The second aperture may be a disc-shaped portion of a plane that is surrounded by the second aperture stop 206B.

The image sensors 204A and 204B may be configured to capture images of light incident upon the image sensors 204A and 204B from a common viewpoint and to provide data to a computing system (i.e. via an input/output interface) representing the respective captured images. The image sensors 204A and 204B may include a CMOS (complementary metal oxide semiconductor) sensor or a CCD (charge-coupled device) sensor, among other possibilities. The image sensors 204A and 204B may be aligned perpendicularly to the optical axis 202 and face the same direction (upward in this example). In this example the first image sensor 204A is located below the second image sensor 204B and along the optical axis 202.

The first wall 207A may provide structural support for the dual imaging system 200. For example, the first image sensor 204A may be mounted to a bottom interior portion of the first wall 207A and/or side portions of the first wall 207A. The first reflector 208A and the second reflector 210A may also be mounted to a bottom or side portion of the first wall 207A. Or, the second reflector 210A may be mounted to the first wall 207A with narrow radial support beams or to a window located coplanar with the first aperture. Structural descriptions included herein are included for illustrative purposes only. Other structural examples are possible.

The first imaging system comprising the first image sensor 204A, the first aperture stop 206A, the first reflector 208A, and the second reflector 210A, may be configured to capture images of the object 220. For example, the light ray 222 may travel from the first end 220A of the object 220, past the second imaging system, and be reflected by the first reflector 208A toward the second reflector 210A. The light ray 222 may further be reflected by the second reflector 210A and become incident upon the first image sensor 204A.

The first reflector 208A may be a curved section of glass or other material coated with a smooth reflective metal layer on one or more surfaces, among other possibilities. The first reflector 208A may be a parabolic or concave reflector configured to reflect incident light rays travelling downward with respect to the optical axis 202 toward a focus of the first reflector 208A. (The focus of the first reflector 208A may be located above the second reflector 210A, but is not depicted in FIG. 2A). The focus of the first reflector 208A may also be a first focus of the second reflector 210A. The first reflector 208A may be symmetrically aligned along the optical axis 202 and located below the second image sensor 204B.

The second reflector 210A may also be a curved section of glass or other material coated with a smooth reflective metal layer on one or more surfaces, among other possibilities. The second reflector 210A may be a hyperbolic or convex reflector configured to reflect incident light rays toward a second focus (not shown) of the second reflector 210A. The second focus of the second reflector 210A may be below the first image sensor 204A. The first reflector 208A may include an opening centered along the optical axis 202 that allows light rays reflected by the second reflector 210A to pass through the opening to the first image sensor 204A.

Similar to the light ray 222, the light ray 224 may travel from the second end 220B of the object 220, past the second imaging system, and be reflected by the first reflector 208A toward the second reflector 210A. The second reflector 210A may reflect the light ray 224 so that it is incident upon the first image sensor 204A. In this way, a real image of the object 220 may be formed upon the first image sensor 204A. Rays of light that originate from a point on the optical axis 202 and travel past the second imaging system (such as light ray 224) may be directed by components of the first imaging system to a point on the first image sensor 204A that is on the optical axis 202.

The first aperture stop 206A may surround a first aperture of the first imaging system and the second aperture stop 206B may surround a second aperture of the second imaging system. The second aperture may be located between the first aperture and the second image sensor 204B. (In another example, the first aperture may be located between the second image sensor 204B and the second reflector 210A, or between the second aperture and the second reflector 210A.) Both the first aperture and the second aperture may be disc-shaped portions of planes respectively surrounded by the first and second aperture stops 206A and 206B. Light that reaches the first image sensor 204A may cross the first aperture while light that reaches the second image sensor 204B may cross the first and second apertures. The diameter of the first aperture may vary as the inner diameter of the first aperture stop 206A is varied.

In another sense, the first aperture stop 206A and the second aperture stop 206B may together define a third annular aperture corresponding to the first imaging system. Light that reaches the first image sensor 204A may cross the annular aperture. See FIG. 2B for more detail of the annular aperture. The aperture stops 206A and 206B may be adjustable so that the first and second image sensors 204A and 204B are configured to capture an image with a common viewpoint and/or with a common field of view.

The second imaging system, with respect to the optical axis 202, may be located radially within the first wall 207A of the first imaging system. The second imaging system could be located anywhere along the optical axis 202 with respect to the first imaging system. For example, the second aperture defined by the second aperture stop 206B could be located in front of, or behind, the first aperture defined by the first aperture stop 206A. Also, the second image sensor could be located in front of, or behind, the first aperture defined by the first aperture stop 206A.

The second image sensor 204B may be located at an image plane of the lens 208B that corresponds to the object 220. The location of the image plane of the lens 208B may be determined by equation 1:

$$\frac{1}{{S}_{1}} + \frac{1}{{S}_{2}} = \frac{1}{f} \qquad [ 1 ]$$

In equation 1 and FIG. 2A, S₁ may represent a distance between the object 220 and the lens 208B along the optical axis 202, S₂ may represent a distance between the image plane (i.e. the second image sensor 204B) and the lens 208B along the optical axis 202, while f may represent a focal length of the lens 208B.

The lens 208B may be a piece of glass or other transparent material machined and/or polished to focus light in accordance with embodiments disclosed herein. For example, the lens 208B may be configured to focus light incident upon the lens 208B to produce a real image of the object 220 upon the second image sensor 204B. Two of the light rays making up the real image of the object 220 are light rays 226 and 228, which respectively represent the first end 220A and the second end 220B of the object 220.

The second aperture stop 206B may define the second aperture through which light may pass and be captured by the second image sensor 204B. The second aperture stop 206B may have a fixed diameter, or may be adjustable to create second apertures of varying diameters. The second aperture corresponding to the second aperture stop 206B may be a disc-shaped portion of a plane parallel to the second aperture stop 206B. In other embodiments, the second aperture stop 206B may define other shapes of apertures, such as a non-circular aperture. An adjustable second aperture stop 206B may define a variable field of view of the second imaging system.

The second wall 207B may provide structural support for the second imaging system. For example, the second image sensor 204B may be mounted to a bottom portion of the second wall 207B and/or side portions of the second wall 207B. The lens 208B may be mounted to side portions of the second wall 207B. The second wall 207B may be mounted to a top non-reflective surface of the second reflector 210A. Structural descriptions included herein are included for illustrative purposes only. Other structural examples are possible.

The lens 208B may be configured to refract light incident upon the lens 208B onto the second image sensor 204B so that the second image sensor 204B may capture images. The second image sensor 204B may lie along the image plane of the lens 208B.

FIG. 2B is a downward view of portions of the example dual imaging system 200 of FIG. 2A, including the second image sensor 204B, the first aperture stop 206A, the second aperture stop 206B, the first wall 207A, the second wall 207B, the second reflector 210A, the first reflector 208A, and an image 230. (The lens 208B is not pictured.) As shown in FIG. 2B, the second image sensor 204B may be mechanically coupled to a structure that includes the second aperture stop 206B, the second wall 207B, and the second reflector 210A. The second aperture stop 206B may be configured to increase or decrease its inner diameter as shown at 236. Such changes in the inner diameter of the second aperture stop 206B may change an amount of light that reaches the second image sensor 204B and a field of view of the second imaging system. A top surface of the second reflector 210A depicted in FIG. 2B may be a non-reflective surface. The image 230 of the object 220 (of FIG. 2A) may be made up of light rays 226 and 228 (of FIG. 2A), among other light rays. Pictured below the second reflector 210A is the first reflector 208A. At the outer edge of FIG. 2B is the first aperture stop 206A. The first aperture stop 206A may be adjustable so that its inner diameter defines the first aperture corresponding to the first imaging system. The first aperture stop 206A may also define an annular aperture 247 corresponding to the first imaging system with an outer radius defined by the first aperture stop 206A and the inner radius defined by the second wall 207B or the second aperture stop 206B. Light that passes through to the first image sensor 204A (not pictured) will first pass through the annular aperture 247 (which is a portion of the first aperture defined by the first aperture stop 206).

FIG. 2C is a downward view of portions of the example dual imaging system of FIG. 2A, including the first image sensor 204A, the first reflector 208A, and an image 240. As shown, light rays 222 and 224 (of FIG. 2A), among other light rays not shown, form the image 240 on the first image sensor 204A. The light rays 222 and 224 may travel through an opening of the first reflector 208A, depicted in FIG. 2C.

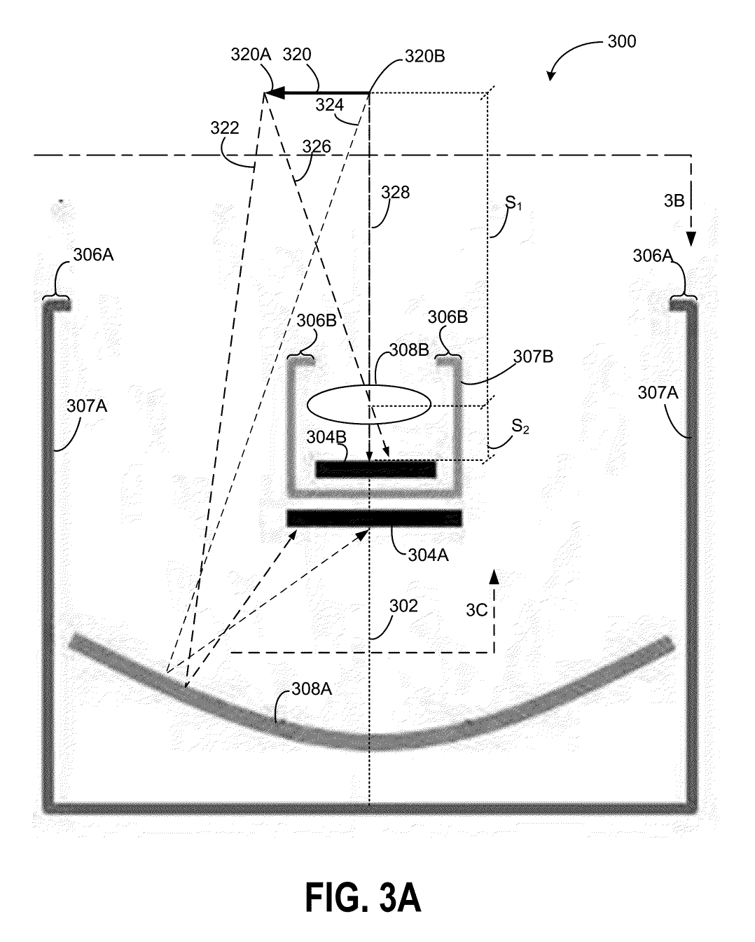

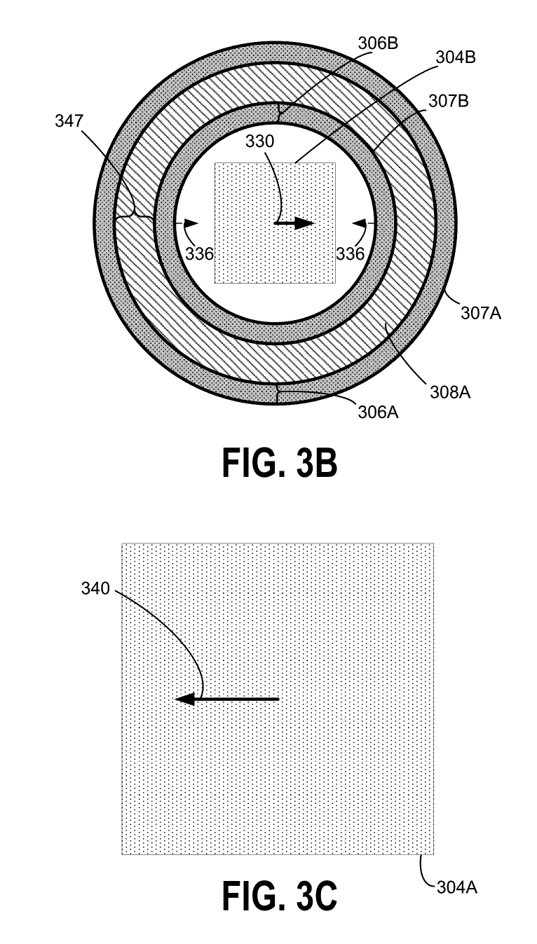

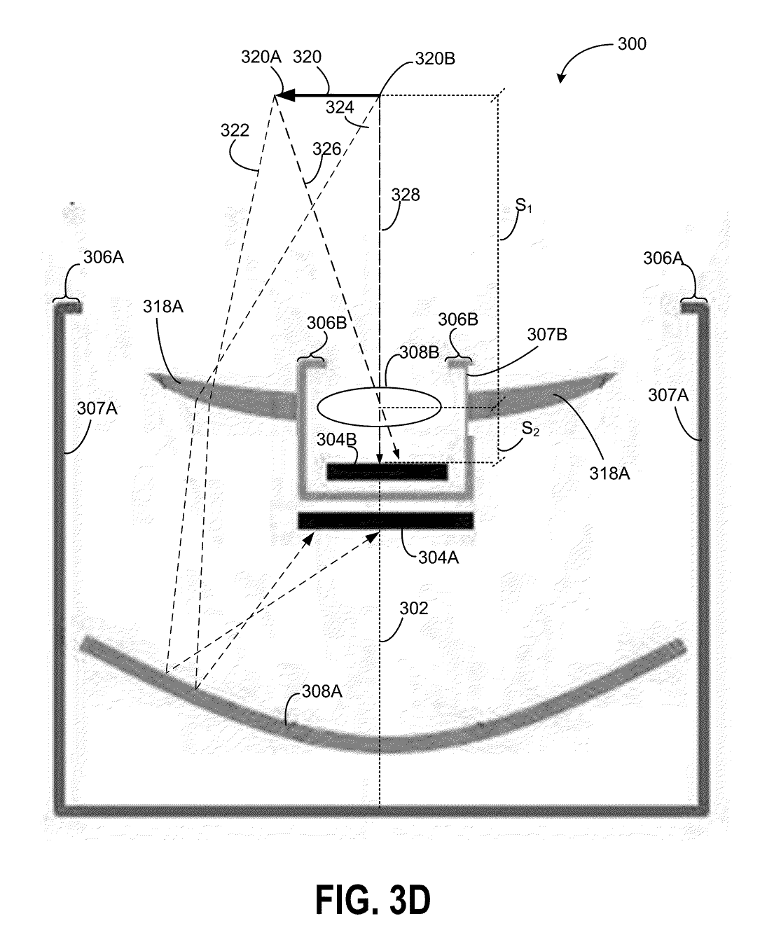

FIG. 3A illustrates a side view cross section of an example dual imaging system 300. The dual imaging system 300 includes a first imaging system comprising a first image sensor 304A, a first aperture stop 306A, a first wall 307A, and a first reflector 308A. The dual imaging system 300 also includes a second imaging system comprising a second image sensor 304B, a second aperture stop 306B, a second wall 307B, and a lens 308B. FIG. 3A further includes an object 320 with a first end 320A and a second end 320B, and light rays 322, 324, 326, and 328. Both the first and second image sensors 304A/304B may be configured to capture light travelling downward relative to the optical axis 302. Although, light captured by the first image sensor 304A may be reflected to travel upward before capture. Portions or components of the dual imaging system 300 may be arranged along, or around, a common optical axis 302.

It should be noted that dimensions of the imaging system 300 or the object 320 represented in FIG. 3A may not be to scale, and are for illustrative purposes only. It should also be noted that any depicted angles and/or directions of refraction or reflection depicted in FIG. 3A are purely for illustrative purposes and are not necessarily to scale.

The optical axis 302 may define an axis of rotational symmetry (or other axis of symmetry) for image sensors 304A and 304B, the aperture stops 306A and 306B, the lens 308B, the first reflector 308A, and the dual imaging system 300 as a whole. For example, a light ray such as the light ray 328 that travels along the optical axis 302 may pass through the lens 308B and reach the second image sensor 304B without being refracted (i.e. having its direction of travel changed).

The image sensors 304A and 304B may be configured to capture images of light incident upon the image sensors 304A and 304B and to provide data to a computing system (i.e. via an input/output interface) representing the respective captured images. The image sensors 304A and 304B may include a CMOS (complementary metal oxide semiconductor) sensor or a CCD (charge-coupled device) sensor, among other possibilities. The image sensors 304A and 304B may be aligned perpendicularly to the optical axis 302, but facing opposite directions. In this example, the first image sensor 304A may face downward while the second image sensor 308B may face upward.

The first wall 307A may provide structural support for the imaging system. Components of the dual imaging system 300 may be mounted (i.e. mechanically coupled) to bottom or side interior portions of the first wall 307A. The first reflector 308A may be mounted to a bottom or side portion of the first wall 307A. Structural descriptions included herein are included for illustrative purposes only. Other structural examples are possible.

The first image sensor 304A, the first aperture stop 306A, and the first reflector 308A may be configured to capture images of the object 320. For example, the light ray 322 may travel from the first end 320A of the object 320, past the second imaging system, and be reflected by the first reflector 308A and become incident upon the first image sensor 304A.

The first reflector 308A may be a curved section of glass coated with a smooth reflective metal layer on one or more surfaces, among other possibilities. The first reflector 308A may be a parabolic or concave reflector configured to reflect incident light rays toward a focus of the first reflector located above the first image sensor 304A. However, light rays may become incident upon the first image sensor 304A before the rays reach the focus of the first reflector 308A. The first reflector 308A may be symmetrically aligned along the optical axis 302 and located below the first image sensor 304A.

Similar to the light ray 322, the light ray 324 may travel from the second end 320B of the object 320, past the second imaging system, and be reflected by the first reflector 308A toward the first image sensor 304A. In this way, a real image of the object 320 is formed upon the first image sensor 304A. Rays of light that originate from a point on the optical axis 302 and travel past the second imaging system (such as light ray 324) may be reflected by the first reflector 308A to a point on the first image sensor 304A that is on the optical axis 302.

The first aperture stop 306A may surround a first aperture of the first imaging system and the second aperture stop 306B may surround a second aperture of the second imaging system. The second aperture may be located between the first aperture and the second image sensor 304B. Both the first aperture and the second aperture may be disc-shaped portions of planes respectively surrounded by the first and second aperture stops 306A and 306B. Light that reaches the first image sensor 304A may cross the first aperture while light that reaches the second image sensor 304B may cross the first and second apertures. The diameter of the first aperture may vary as the inner diameter of the first aperture stop 306A is varied.

In another sense, the first aperture stop 306A and the second aperture stop 306B may together define a third annular aperture corresponding to the first imaging system. Light that reaches the first image sensor 304A may cross the annular aperture. See FIG. 3B for more detail of the annular aperture. The aperture stops 306A and 306B may be adjustable so that the first and second image sensors 304A and 304B are configured to capture an image with a common viewpoint and/or with a common field of view.

The second imaging system, with respect to the optical axis 302, may be located radially within the first wall 307A of the first imaging system. The second imaging system could be located anywhere along the optical axis 302 with respect to the first imaging system. For example, the second aperture defined by the second aperture stop 306B could be located in front of, or behind, the first aperture defined by the first aperture stop 306A. Also, the second image sensor could be located in front of, or behind, the first aperture defined by the first aperture stop 306A.

The second image sensor 304B may be located at an image plane of the lens 308B that corresponds to the object 320. The location of the image plane of the lens 308B may be determined by equation 1, discussed above. In equation 1 and FIG. 3A, S₁ may represent a distance between the object 320 and the lens 308B along the optical axis 302, S₂ may represent a distance between the image plane (i.e. the second image sensor 304B) and the lens 308B along the optical axis 302, while f may represent a focal length of the lens 308B.

The lens 308B may be a piece of glass or other transparent material machined to focus light in accordance with embodiments disclosed herein. For example, the lens 308B may be configured to focus light incident upon the lens 308B to produce a real image of object 320 upon the second image sensor 304B. Two of the rays making up the real image of the object 320 are rays 326 and 328, which respectively represent the first end 320A and the second end 320B of the object 320.

The second aperture stop 306B may define a second aperture through which light may pass and be captured by the second image sensor 304B. The second aperture stop 306B may have a fixed diameter, or may be adjustable to create second apertures of varying diameters. The second aperture corresponding to the second aperture stop 306B may be a disc-shaped portion of a plane parallel to, and surrounded by, the second aperture stop 306B. In other embodiments, the second aperture stop 306B may define other shapes of apertures, such as a non-circular aperture. An adjustable second aperture stop 306B may also define a variable field of view of the second imaging system.

The second wall 307B may provide structural support for the dual imaging system (i.e. components of the dual imaging system may be mechanically coupled to the second wall 307B). For example, the second image sensor 304B may be mounted to a bottom portion of the second wall 307B and/or side portions of the second wall 307B. The lens 308B may be mounted to side portions of the second wall 307B. The second wall 307B may be mounted to a top, non-light-sensitive surface of the first image sensor 304A. Structural descriptions included herein are included for illustrative purposes only. Other structural examples are possible.

The lens 308B may be configured to refract light incident upon the lens 308B onto the second image sensor 304B so that the second image sensor 304B may capture images. The second image sensor 304B may lie along the image plane of the lens 308B.

FIG. 3B is a downward view of portions of the example dual imaging system of FIG. 3A, including the second image sensor 304B, the first aperture stop 306A, the second aperture stop 306B, the first wall 307A, the second wall 307B, the first reflector 308A, and an image 330. The lens 308B is not shown in FIG. 3B.

As shown in FIG. 3B, the second image sensor 304B may be mechanically coupled to a structure that includes the second aperture stop 306B and the second wall 307B. The second aperture stop 306B may be configured to increase or decrease its inner diameter as shown at 336. Such changes in the inner diameter of the second aperture stop 306B may change an amount of light that reaches the second image sensor 304B and a field of view of the second imaging system. The image 330 of the object 320 (of FIG. 3A) may be made up of light rays 326 and 328 (of FIG. 3A), among other light rays. Toward the outer edge of the imaging system is the first aperture stop 306A. The first aperture stop 306A may also be adjustable and define an annular aperture 347 of the first imaging system, with an outer radius defined by the first aperture stop 306A and the inner radius defined by the second wall 307B or the second aperture stop 306B.

FIG. 3C illustrates an example image sensor of the system of FIG. 3A. FIG. 3C provides an upward looking view of the first image sensor 304A. In this example, light rays 322 and 324 (among other rays) have travelled from the object 320, past the second imaging system, and reflected off of the first reflector 308A such that the image 340 is formed on the first image sensor 304A.

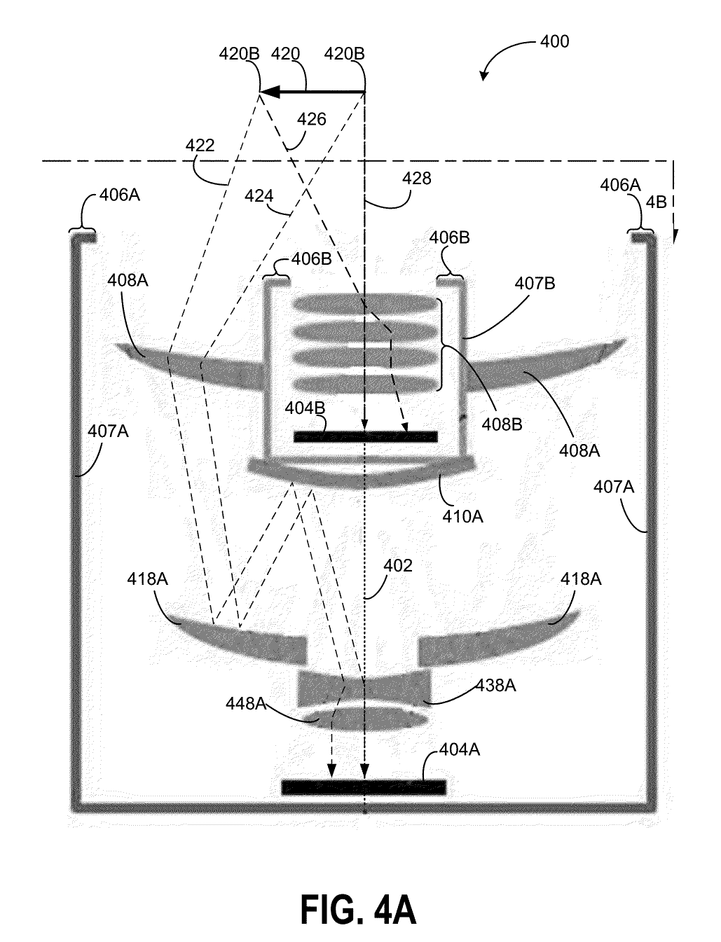

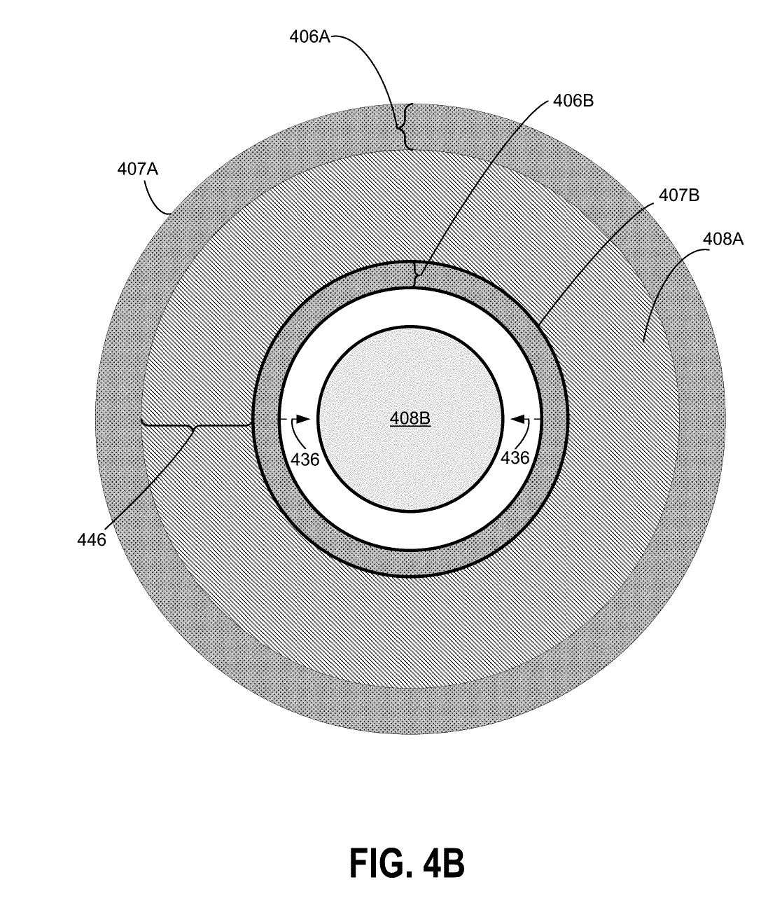

FIG. 3D illustrates a side view cross section of an example dual imaging system 300. The dual imaging system includes a first imaging system comprising a first image sensor 304A, a first aperture stop 306A, a first wall 307A, a first reflector 308A, and a lens 318A. The dual imaging system also includes a second imaging system comprising a second image sensor 304B, a second aperture stop 306B, and a second wall 307B. FIG. 3D further includes an object 320 with a first end 320A and a second end 320B, and light rays 322, 324, 326 and 328. The dual imaging system of FIG. 3D may be similar to the system depicted in FIG. 3A, however the dual imaging system of FIG. 3D may include the lens 318A as an additional optical element. The lens 318A may have functionality similar to that of the lens 408A described below with regard to FIG. 4A.

FIG. 4A illustrates a side view cross section of an example dual imaging system 400. The dual imaging system includes a first imaging system comprising a first image sensor 404A, a first aperture stop 406A, a first wall 407A, a lens 408A, a first reflector 418A, a second reflector 410A, and lenses 438A and 448A. The dual imaging system also includes a second imaging system comprising a second image sensor 404B, a second aperture stop 406B, a second wall 407B, and a plurality of lenses 408B. FIG. 4A further includes an object 420 with a first end 420A and a second end 420B, and light rays 422, 424, 426 and 428. Both the first and second image sensors 404A and 404B may face upward and be configured to capture light travelling downward relative to the optical axis 402. Portions or components of the dual imaging system 400 may be arranged along, or around, a common optical axis 402.

It should be noted that dimensions of the imaging system 400 or the object 420 represented in FIG. 4 may not be to scale, and are for illustrative purposes only. It should also be noted that any depicted angles and/or directions of refraction or reflection depicted in FIG. 4 are purely for illustrative purposes and are not necessarily to scale.

The optical axis 402 may define an axis of rotational symmetry (or other axis of symmetry) for the image sensors 404A and 404B, the aperture stops 406A and 406B, the plurality of lenses 408B, the lens 408A, the first reflector 418A, the second reflector 410A, the lenses 438A and 448A, and the dual imaging system 400 as a whole. For example, a light ray such as the light ray 428 that travels along the optical axis 402 may pass through the plurality of lenses 408B and reach the second image sensor 404B without being refracted (i.e. having its direction of travel changed).

The image sensors 404A and 404B may be configured to capture images of light incident upon the image sensors 404A and 404B and to provide data to a computing system (i.e. via an input/output interface) representing the respective captured images. The image sensors 404A and 404B may include a CMOS (complementary metal oxide semiconductor) sensor or a CCD (charge-coupled device) sensor, among other possibilities. The image sensors 404A and 404B may be aligned perpendicularly to the optical axis 402 facing upward with respect to the optical axis 402.

The first wall 407A may provide structural support to the dual imaging system 400. Components of the dual imaging system 400 may be mounted (i.e. mechanically coupled) to bottom or side interior portions of the first wall 407A. Components of the first imaging system, such as the lenses 408A, 438A, and 448A, the first reflector 418A, and the second reflector 410A may also be mounted to a bottom or side portion of the first wall 407A. Structural descriptions included herein are included for illustrative purposes only. Other structural examples are possible.

The first image sensor 404A, the first aperture stop 406A, the lenses 408A, 438A, and 448A, the first reflector 418A, and the second reflector 410A may be configured to capture images of the object 420. For example, the light ray 422 may travel from the first end 420A of the object 420, be refracted by the lens 408A, travel past the second imaging system, be reflected sequentially by the first reflector 418A and the second reflector 410A, be refracted by the lenses 438A and 448A, and become incident upon the first image sensor 404A.

The reflectors 418A and 410A may be curved sections of glass or other material coated with a smooth reflective metal layer on one or more surfaces, among other possibilities. The reflectors 418A and 410A may also be dual purpose reflector/refractors, each having a front refractive element and a back reflective surface. For example, light may be refracted through the front refractive element, be reflected by the back reflective surface, and be refracted by the front refractive element as the light passes through the refractive element again. The lenses 408A, 438A, and 448A may be pieces of glass or other translucent material machined to focus light in accordance with embodiments disclosed herein.

Similar to the light ray 422, the light ray 424 may travel from the second end 420B of the object 420, be refracted by the lens 408A, travel past the second imaging system, be reflected sequentially by the first reflector 418A and the second reflector 410A, be refracted by the lenses 438A and 448A, and become incident upon the first image sensor 404A. In this way, a real image of the object 420 is formed upon the first image sensor 404A. Note that rays of light that originate from a point on the optical axis 402 and travel past the second imaging system (such as light ray 424) may be redirected by the first imaging system to a point on the first image sensor 404A that is on the optical axis 402.

The first aperture stop 406A may surround a first aperture of the first imaging system and the second aperture stop 406B may surround a second aperture of the second imaging system. The second aperture may be located between the first aperture and the second image sensor 404B. (In other examples, the first aperture may be located between the second aperture and the second reflector 410A.) Both the first aperture and the second aperture may be disc-shaped portions of planes respectively surrounded by the first and second aperture stops 406A and 406B. Light that reaches the first image sensor 404A may cross the first aperture while light that reaches the second image sensor 404B may cross the first and second apertures. The diameter of the first aperture may vary as the inner diameter of the first aperture stop 406A is varied.

In another sense, the first aperture stop 406A and the second aperture stop 406B may together define a third annular aperture corresponding to the first imaging system. Light that reaches the first image sensor 404A may cross the annular aperture. See FIG. 4B for more detail of the annular aperture. The aperture stops 406A and 406B may be adjustable so that the first and second image sensors 404A and 404B are configured to capture an image with a common viewpoint and/or with a common field of view.

The second imaging system, with respect to the optical axis 402, may be located radially within the first wall 407A of the first imaging system. The second imaging system could be located anywhere along the optical axis 402 with respect to the first imaging system. For example, the second aperture defined by the second aperture stop 406B could be located in front of, or behind, the first aperture defined by the first aperture stop 406A. Also, the second image sensor could be located in front of, or behind, the first aperture defined by the first aperture stop 406A.

The second image sensor 404B may be located at an image plane of the plurality of lenses 408B that corresponds to the object 420. For example, the plurality of lenses 408B may be configured to focus light incident upon the plurality of lenses 408B to produce a real image of object 420 upon the second image sensor 404B. Two of the rays making up the real image of the object 420 are rays 426 and 428, which respectively represent the first end 420A and the second end 420B of the object 420.

The second aperture stop 406B may define a second aperture through which light may pass and be captured by the second image sensor 404B. The second aperture stop 406B may have a fixed diameter, or may be adjustable to create second apertures of varying diameters. The second aperture corresponding to the second aperture stop 406B may be a disc-shaped portion of a plane parallel to, and surrounded by, the second aperture stop 406B. In other embodiments, the second aperture stop 406B may define other shapes of apertures, such as a non-circular aperture. An adjustable second aperture stop 406B may define a variable field of view of the second imaging system. In this example, the second aperture is located between the first aperture and the second image sensor 404B.

The second wall 407B may provide structural support for the dual imaging system (i.e. components of the dual imaging system may be mechanically coupled to the second wall 407B). For example, the second image sensor 404B may be mounted to a bottom portion of the second wall 407B and/or side portions of the second wall 407B. The plurality of lenses 408B may be mounted to side portions of the second wall 407B. The second wall 407B may be mounted to a top, non-light sensitive surface of the second reflector 410A. Structural descriptions included herein are included for illustrative purposes only. Other structural examples are possible.

The plurality of lenses 408B may be configured to refract light incident upon the plurality of lenses 408B onto the second image sensor 404B so that the second image sensor 404B may capture images. The second image sensor 404B may lie along an image plane of the plurality of lenses 408B corresponding to the object 420.

FIG. 4B illustrates a downward looking view of the example dual imaging system of FIG. 4A, including the plurality of lenses 408B, the first aperture stop 406A, the second aperture stop 406B, the first wall 407A, the second wall 407B, and the lens 408A. The plurality of lenses 408B may be mechanically coupled to a bottom or side portion of the second wall 407B. The second aperture stop 406B may be configured to increase or decrease its inner diameter to increase or decrease a size of the second aperture, as shown at 436. The first aperture stop 406A may be configured to increase or decrease its inner diameter to increase or decrease a size of the annular aperture 446 and the first aperture. The lens 408A may be mounted to an exterior of the second wall 407B, or may be mounted to an interior of the first wall 407A. Other examples are possible.

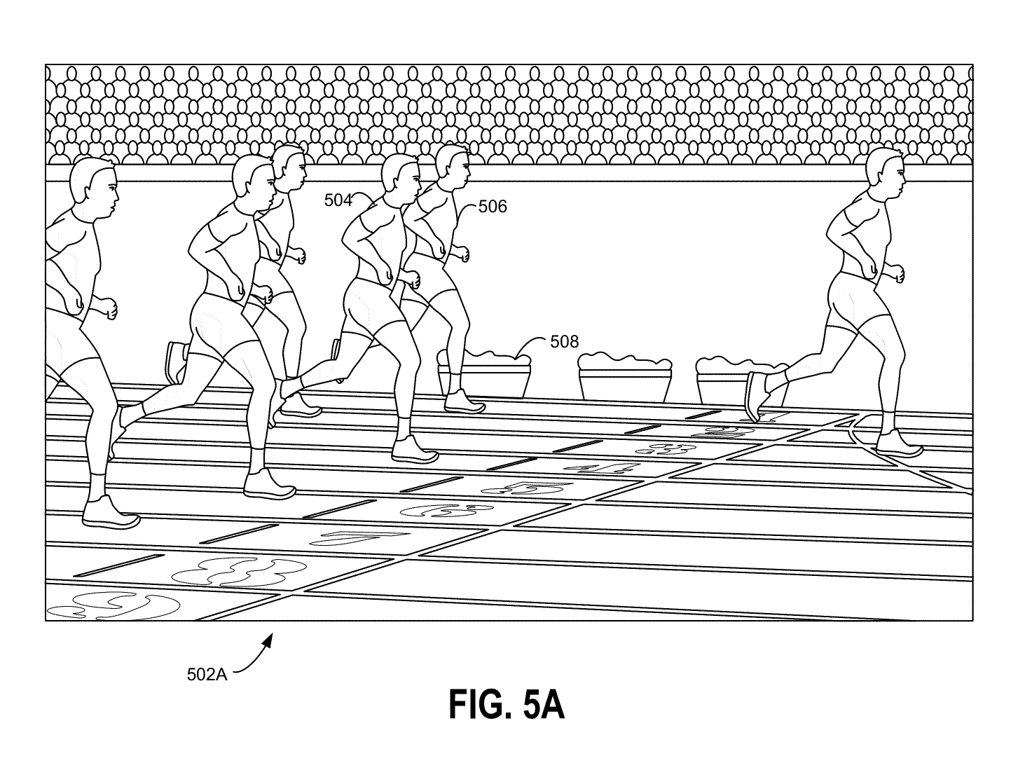

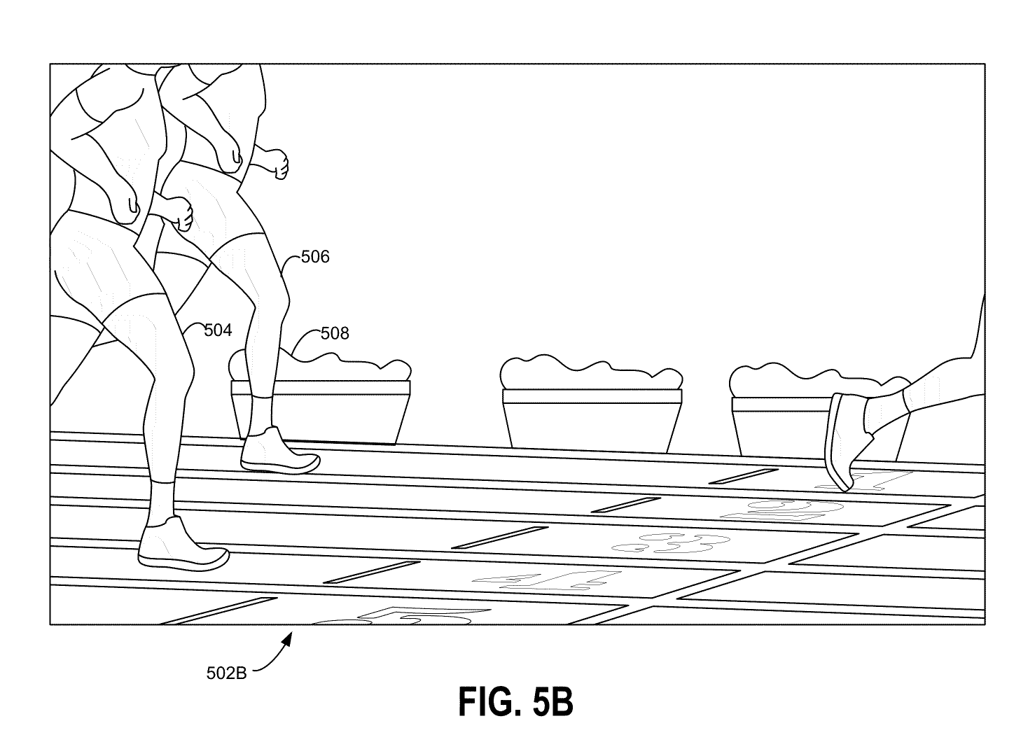

FIGS. 5A and 5B illustrate images captured by respective image sensors. In FIG. 5A, image 502A could be an image captured by the first image sensor 204A, 304A, or 404A of FIGS. 2A, 3A, and 4A, respectively. Accordingly, the image 502B of FIG. 5B could be an image simultaneously captured by the second image sensor 204B, 304B, or 404B of FIGS. 2A, 3A, and 4A, respectively.

Alternatively, the image 502A could be captured by the second image sensor 204B, 304B, or 404B of FIGS. 2A, 3A, and 4A, respectively. Accordingly, the image 502B could be captured by the first image sensor 204A, 304A, or 404A of FIGS. 2A, 3A, and 4A, respectively.

As shown in FIGS. 5A and 5B, the first and second image sensors depicted in FIGS. 2A, 3A, and 4A may be configured to simultaneously capture an image of light sources or light reflecting off objects from a common viewpoint and with very little (or zero) parallax disparity. For example, the first object 504 (e.g. a first runner), the second object 506 (e.g. a second runner), and the third object 508 (e.g. a flower pot) may have the same apparent spatial relationships in both images 502A and 502B. For instance, the first object 504 may appear to be in front of the second object 506, and the second object 506 may appear to be in front of the third object 508. Also, the objects may appear to overlap at the same places in both images 502A and 502B. For instance, the first runner's right leg (i.e. first object 504) may appear to be in front of the second runner's left leg (i.e. the second object 506). Also, the second runner's right leg (i.e. the second object 506) may appear to be in front of the flower pot (i.e. the third object 508). It should be noted that the images 502A and 502B depict a common viewpoint (i.e. both images share a common optical axis).

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A system comprising:
(i) a first imaging system comprising:
a first image sensor;
a first aperture that defines, at least in part, a field of view of the first imaging system;
a first reflector comprising an opening, wherein the first reflector faces the first aperture;
a second reflector that faces the first reflector, wherein the second reflector is located between the first aperture and the first reflector, and wherein the first image sensor, the first aperture, the first reflector, and the second reflector are all arranged around a common optical axis; and
(ii) a second imaging system arranged substantially within the first imaging system, wherein the second imaging system comprises:
a second image sensor; and
a second aperture that defines, at least in part, a field of view of the second imaging system, wherein the field of view of the first imaging system is wider than the field of view of the second imaging system, wherein the second aperture and the second image sensor are arranged around the common optical axis, and wherein the second reflector is located between the first reflector and the second image sensor and between the first reflector and the second aperture, such that the field of view of the first imaging system and the field of view of the second imaging system are both substantially centered on the common optical axis.

2. The system of claim 1, wherein the second aperture and the second image sensor are located between the first aperture and the second reflector.

3. The system of claim 1, wherein the first imaging system is arranged such that at least some light emitted by a light source on the common optical axis passes through the first aperture to the first reflector, is reflected from the first reflector to the second reflector, and is then reflected from the second reflector through the opening and onto the first image sensor.

4. The system of claim 1, wherein the second imaging system is arranged substantially within the first imaging system such that at least some light emitted by a light source on the common optical axis passes through both the first aperture and the second aperture to reach the second image sensor.

5. The system of claim 1, wherein the first reflector is a concave reflector configured to reflect light incident upon the first reflector toward a focus of the first reflector.

6. The system of claim 5, wherein the second reflector is a convex reflector, wherein the first reflector is configured to reflect light incident upon the first reflector toward a focus of the second reflector.

7. The system of claim 5, wherein the second reflector is a convex reflector configured to reflect light incident upon the second reflector toward a focus of the second reflector.

8. The system of claim 1, wherein the first image sensor and the second image sensor substantially face the same direction.

9. A system comprising:
(i) a first imaging system comprising:
a first image sensor;
a first aperture that defines, at least in part, a field of view of the first imaging system; and
a first reflector that faces the first aperture, wherein the first image sensor, the first aperture, and the first reflector are all arranged around a common optical axis; and
(ii) a second imaging system arranged substantially within the first imaging system, wherein the second imaging system comprises:
a second image sensor; and
a second aperture that defines, at least in part, a field of view of the second imaging system, wherein the second aperture and the second image sensor are arranged around the common optical axis, and wherein the first image sensor is located between the first reflector and the second image sensor and between the first reflector and the second aperture, such that the field of view of the first imaging system and the field of view of the second imaging system are both substantially centered on the common optical axis.

10. The system of claim 9, wherein the second aperture and the second image sensor are located between the first aperture and the first image sensor.

11. The system of claim 9, wherein the first imaging system is arranged such that at least some light emitted by a light source on the common optical axis passes through the first aperture to the first reflector and is reflected from the first reflector to the first image sensor.

12. The system of claim 9, wherein the second imaging system is arranged substantially within the first imaging system such that at least some light emitted by a light source on the common optical axis passes through both the first aperture and the second aperture to reach the second image sensor.

13. The system of claim 9, wherein the first image sensor and the second image sensor face substantially opposite directions.

14. A system comprising:
(i) a first imaging system comprising:
a first image sensor;
a first aperture that defines, at least in part, a field of view of the first imaging system;
a first reflector comprising an opening, wherein the first reflector faces the first aperture;
a second reflector that faces the first reflector, wherein the second reflector is located between the first aperture and the first reflector; and
at least one lens, wherein the first image sensor, the first aperture, the first reflector, the second reflector, and the at least one lens are all arranged around a common optical axis; and
(ii) a second imaging system arranged substantially within the first imaging system, wherein the second imaging system comprises:
a second image sensor; and
a second aperture that defines, at least in part, a field of view of the second imaging system, wherein the second aperture and the second image sensor are arranged around the common optical axis, and wherein the second reflector is located between the second image sensor and the first reflector and between the second aperture and the first reflector, such that the field of view of the first imaging system and the field of view of the second imaging system are both substantially centered on the common optical axis.

15. The system of claim 14, wherein the second aperture and the second image sensor are located between the first aperture and the second reflector.

16. The system of claim 14, wherein the first imaging system is arranged such that at least some light emitted by a light source on the common optical axis passes through the first aperture to the first reflector, is reflected from the first reflector to the second reflector, and is then reflected from the second reflector through the opening and onto the first image sensor.

17. The system of claim 16, wherein the light emitted by the light source is refracted by the at least one lens.

18. The system of claim 14, wherein the second imaging system is arranged substantially within the first imaging system such that at least some light emitted by a light source on the common optical axis passes through both the first aperture and the second aperture to reach the second image sensor.

19. The system of claim 14, wherein the first reflector is a concave reflector configured to reflect light incident upon the first reflector toward a focus of the first reflector.

20. The system of claim 19, wherein the first image sensor and the second image sensor substantially face the same direction.
